(19) United States
(12) Patent Application Publication
(10) Pub. No.: US 2026/0302287 A1
(43) Pub. Date: Oct. 1, 2026

(54) FUEL CELL ACTIVATION DEVICE

(71) Applicant: HONDA MOTOR CO., LTD., Tokyo (JP)

(72) Inventors: Ken Tagawa, Wako-shi (JP); Ryo Mochizuki, Wako-shi (JP); Shinsaku Takikawa, Wako-shi (JP); Takuro Sasaki, Wako-shi (JP)

(21) Appl. No.: 19/551,682

(22) Filed: Feb. 27, 2026

(30) Foreign Application Priority Data
Mar. 31, 2025 (JP) 2025-058756

(51) Int. Cl. H01M 8/04225; H01M 4/92; H01M 8/0432; H01M 8/0438; H01M 8/04492; H01M 8/04537; H01M 8/04701; H01M 8/04746; H01M 8/04828; H01M 8/1018

(52) U.S. Cl. CPC H01M 8/04225; H01M 4/92; H01M 8/04358; H01M 8/04388; H01M 8/04395; H01M 8/04492; H01M 8/04552; H01M 8/04582; H01M 8/04708; H01M 8/04753; H01M 8/04835; H01M 8/1018

(57) ABSTRACT

A fuel cell activation device activates a fuel cell unit. The fuel cell activation device includes a first gas supply means having a first heating means configured to heat hydrogen-containing anode gas, the first gas supply means being configured to supply the anode gas to an anode electrode; a second gas supply means having a second heating means configured to heat oxygen-containing cathode gas, the second gas supply means being configured to supply the cathode gas to a cathode electrode; a control means configured to control the temperatures of anode gas and cathode gas; a cell temperature detection means configured to measure a temperature in the fuel cell unit; and a relative humidity detection means configured to measure a relative humidity in the fuel cell unit. The control means is configured to execute heating of the anode gas and/or the cathode gas.

### CROSS-REFERENCE TO RELATED APPLICATION

Priority is claimed on Japanese Patent Application No. 2025-058756, filed Mar 31. 2025, the content of which is incorporated herein by reference.

### BACKGROUND OF THE INVENTION

### Field of the Invention

The present invention relates to a fuel cell activation device.

### Description of Related Art

In the related art, efforts aimed at mitigating climate change or alleviating the impacts thereof have been ongoing, and research and development related to reducing carbon dioxide emissions has been conducted to realize this goal. From this perspective, fuel cell vehicles (FCVs) equipped with a fuel cell have attracted attention. The reason is that fuel cell vehicles emit only water (H₂O) and do not emit gases such as CO₂, NO_{X}, and SO_{X}.

Generally, fuel cells mounted in fuel cell vehicles have a fuel cell stack. The fuel cell stack is formed by stacking a plurality of flat-plate fuel cell units. Each fuel cell unit has a membrane electrode assembly (MEA) and a pair of separators disposed on both sides of the membrane electrode assembly.

A membrane electrode assembly includes a solid polymer electrolyte membrane (which will hereinafter be referred to as an electrolyte membrane) having a first end surface and a second end surface, an anode electrode (fuel electrode) provided on the first end surface of the electrolyte membrane, and a cathode electrode (oxidant electrode) provided on the second end surface of the electrolyte membrane. That is, a membrane electrode assembly is configured to sandwich an electrolyte membrane between an anode electrode and a cathode electrode.

In a fuel cell, hydrogen is supplied as anode gas (fuel) to the anode electrode of the membrane electrode assembly. In addition, cathode gas (oxidant) containing oxygen, such as air, is supplied to the cathode electrode of the membrane electrode assembly. Further, hydrogen ions generated by a reaction between hydrogen and a catalyst in the anode electrode pass through the electrolyte membrane and are transferred to the cathode electrode, where they cause an electrochemical reaction with oxygen in the cathode gas (O₂+4H⁺+4e^{‒}→2H₂O) in the cathode electrode, thereby generating power.

Therefore, in each fuel cell unit, water is produced during power generation.

In fuel cells, activation (aging operation) of fuel cell units is usually performed before the first operation. By activating the fuel cell units, hydrogen ions or the like can be transferred more easily inside the fuel cell units, thereby achieving sufficient power generation performance.

Examples of techniques for activating fuel cell units include a method in which hydrogen is supplied as anode gas to an anode electrode and a mixed gas of nitrogen and air is introduced as cathode gas to a cathode electrode.

Patent Document 1 describes an activation device activating an electrolyte membrane electrode assembly (MEA) for fuel cells. Patent Document 1 describes that wet gas may be distributed through a first gas flow channel and a second gas flow channel during a process of activating the electrolyte membrane electrode assembly. In addition, Patent Document 1 describes that the amount of liquid water generated from activation gas can be appropriately controlled by adjusting a local temperature of the activation gas in the gas flow channels.

Patent Document 2 describes a fuel cell control system including a control unit that controls at least one of a cell temperature, a flow rate of fuel gas or oxidizing gas, a back pressure, and a current density of a fuel cell during aging operation of the fuel cell such that water in the fuel cell is present in a liquid phase. Patent Document 2 also describes that the cell temperature is regarded as being equivalent to the temperature of a coolant (exit temperature of a refrigerant) emitted from the fuel cell. Patent Document 2 further describes, as a thermometer for detecting a temperature corresponding to the cell temperature of the fuel cell, a thermometer for measuring the temperature of the coolant emitted from the fuel cell.

### Patent Documents

[Patent Document 1] Japanese Unexamined Patent Application, First Publication No. 2024-051544

[Patent Document 2] Japanese Unexamined Patent Application, First Publication No. 2013-187037

### SUMMARY OF THE INVENTION

When fuel cell units of a fuel cell are activated, if the oxygen concentration in cathode gas introduced into a cathode electrode of a membrane electrode assembly is increased, the amount of water produced by power generation for activation increases. If the amount of water produced during power generation is sufficiently large, electrolyte membranes of the membrane electrode assembly can be sufficiently hydrated. For this reason, the proton conductivity in the membrane electrode assembly is improved, and an excellent activation effect can be achieved, which is extremely advantageous.

However, if an excessive amount of water is produced by power generation for activation, so-called flooding in which a liquid film is formed in the cathode electrode occurs due to water produced in the fuel cell units. If flooding occurs, a flow of gas in the fuel cell units is disrupted so that the activation effect deteriorates. For this reason, in the technology in the related art, it has been required to prevent flooding from occurring during activation of fuel cell units of a fuel cell.

This application has been made in consideration of the foregoing problems, and an object thereof is to provide a fuel cell activation device in which flooding can be prevented from occurring during activation of fuel cell units of a fuel cell and an excellent activation effect can be achieved.

In order to resolve the foregoing problems, the following means are provided.

A fuel cell activation device according to a first aspect of the present invention is a fuel cell activation device (40) activating a fuel cell unit (30) having an anode electrode (14), a cathode electrode (16), and a solid polymer electrolyte membrane (12) sandwiched between the anode electrode (14) and the cathode electrode (16).

The fuel cell activation device (40) includes a first gas supply means (110) having a first heating means (118) configured to heat hydrogen-containing anode gas, the first gas supply means being configured to supply the anode gas to the anode electrode (14); a second gas supply means (130) having a second heating means (138) configured to heat oxygen-containing cathode gas, the second gas supply means being configured to supply the cathode gas to the cathode electrode (16); a control means (154) configured to control a temperature of anode gas supplied by the first gas supply means (110) and a temperature of the cathode gas supplied by the second gas supply means (130); a cell temperature detection means (5) configured to measure a temperature in the fuel cell unit (30); and a relative humidity detection means (540) configured to measure a relative humidity in the fuel cell unit (30).

The control means (154) is configured to execute heating of the anode gas and/or the cathode gas when a water vapor content in the fuel cell unit (30) is equal to or larger than a saturation water vapor content.

In the fuel cell activation device (40) according to the first aspect, the control means (154) executes heating of the anode gas and/or the cathode gas when the water vapor content in the fuel cell unit (30) is equal to or larger than the saturation water vapor content. For this reason, according to the fuel cell activation device (40) of the first aspect, when the fuel cell unit (30) is activated using this, it is possible to prevent flooding from occurring in the fuel cell unit (30), and it is possible to sufficiently achieve the effect obtained by performing activation.

According to the fuel cell activation device of a second aspect of the present invention, in the foregoing first aspect, the cathode gas is low-oxygen gas having a lower oxygen concentration than air. In the fuel cell activation device according to the second aspect, since the cathode gas supplied to the fuel cell unit (30) is low-oxygen gas having a lower oxygen concentration than air, for example, compared to when the cathode gas is air or high-oxygen gas having an oxygen concentration equal to or higher than that of air, the amount of water produced during activation of the fuel cell unit (30) is suppressed. As a result, it is possible to prevent an excessive amount of water produced during activation of the fuel cell unit (30) of the fuel cell, and it is possible to more effectively prevent flooding from occurring in the fuel cell unit (30).

According to the fuel cell activation device of a third aspect of the present invention, in the foregoing first aspect, one or both of the anode electrode (14) and the cathode electrode (16) have a catalyst layer containing platinum catalysts (18, 22). In the fuel cell activation device according to the third aspect, since one or both of the anode electrode (14) and the cathode electrode (16) have a catalyst layer containing platinum catalysts (18, 22), it is easy to achieve the effect obtained by activating the fuel cell unit 30, and it is possible to obtain a fuel cell having sufficient power generation performance.

According to the fuel cell activation device of a fourth aspect of the present invention, in the foregoing first aspect, the first gas supply means (110) has a first humidifier (118) humidifying hydrogen-containing anode gas. The second gas supply means (130) has a second humidifier (138) humidifying oxygen-containing cathode gas.

In the fuel cell activation device according to the fourth aspect, the hydrogen-containing anode gas can be humidified by the first humidifier (118), and the oxygen-containing cathode gas can be humidified by the second humidifier (138). For this reason, the solid polymer electrolyte membrane (12) provided in the fuel cell unit (30) can be sufficiently hydrated. Accordingly, the proton conductivity in a membrane electrode assembly (MEA) 10 is improved, and a better activation effect can be achieved.

According to the fuel cell activation device of a fifth aspect of the present invention, in the foregoing first aspect, the cell temperature detection means (5) has a cell potential detection means (173) configured to detect a potential of the fuel cell unit (30). The control means (154) is configured to calculate the temperature in the fuel cell unit (30) on the basis of a change in the potential of the fuel cell unit (30) detected by the cell potential detection means (173).

In the fuel cell activation device according to the fifth aspect, the control means (154) calculates the temperature in the fuel cell unit (30) on the basis of a change in the potential of the fuel cell unit (30) detected by the cell potential detection means (173). For this reason, the cell potential detection means (173) for measuring the potential of the fuel cell unit (30) can function as the cell temperature detection means (5) for measuring the temperature in the fuel cell unit (30). As a result, in the fuel cell activation device according to the fifth aspect, while activation of the fuel cell unit (30) is performed, it is possible to measure the temperature in the fuel cell unit (30) rising during power generation of the fuel cell unit (30) in a contactless manner at predetermined time intervals.

According to the fuel cell activation device of a sixth aspect of the present invention, in the foregoing first aspect, the cell temperature detection means (5) has a gas supply amount detection means (116, 136) configured to detect a flow rate of hydrogen supplied by the first gas supply means (110) and a flow rate of oxygen supplied by the second gas supply means (130). The control means (154) is configured to calculate an oxygen supply ratio that is a ratio of the flow rate of the oxygen to the flow rate of the hydrogen on the basis of the flow rate of the hydrogen and the flow rate of the oxygen detected by the gas supply amount detection means (116, 136) and calculates the temperature in the fuel cell unit (30) using the result thereof.

In the fuel cell activation device according to the sixth aspect, the control means (154) calculates the oxygen supply ratio that is a ratio of the flow rate of oxygen to the flow rate of hydrogen on the basis of the flow rate of hydrogen detected by the gas supply amount detection means (116) and the flow rate of oxygen detected by the gas supply amount detection means (136) and calculates the temperature in the fuel cell unit (30) using the result thereof. For this reason, the gas supply amount detection means (116, 136) can function as the cell temperature detection means (5) for measuring the temperature in the fuel cell unit (30). As a result, in the fuel cell activation device according to the sixth aspect, while activation of the fuel cell unit (30) is performed, it is possible to measure the temperature in the fuel cell unit (30) rising during power generation of the fuel cell unit (30) in a contactless manner at predetermined time intervals.

According to the fuel cell activation device of a seventh aspect of the present invention, in the foregoing sixth aspect, the control means (154) is configured to control the flow rate of hydrogen supplied by the first gas supply means (110) and the flow rate of oxygen supplied by the second gas supply means (130). Reduction of the oxygen supply ratio is executed when the water vapor content in the fuel cell unit (30) is equal to or larger than the saturation water vapor content.

In the fuel cell activation device according to the seventh aspect, the control means (154) executes reduction of the oxygen supply ratio when the water vapor content in the fuel cell unit (30) is equal to or larger than the saturation water vapor content. For this reason, in the fuel cell activation device according to the seventh aspect, when the water vapor content in the fuel cell unit (30) becomes equal to or larger than the saturation water vapor content, the electrochemical reaction is suppressed as a result of insufficient oxygen, and the amount of power generation during activation of the fuel cell unit (30) is reduced. As a result, the amount of water produced by power generation for activation decreases, and it is possible to more effectively prevent flooding from occurring during activation of the fuel cell unit (30).

According to the fuel cell activation device of an eighth aspect of the present invention, in the foregoing first aspect, the cell temperature detection means (5) has a coolant temperature detection means (530) configured to detect a temperature of a coolant for cooling the fuel cell unit (30). The control means (154) is configured to calculate the temperature in the fuel cell unit (30) on the basis of a change in the temperature of the coolant detected by the coolant temperature detection means (530).

In the fuel cell activation device according to the eighth aspect, the control means (154) calculates the temperature in the fuel cell unit (30) on the basis of a change in the temperature of the coolant detected by the coolant temperature detection means (530). For this reason, the coolant temperature detection means (530) can function as the cell temperature detection means (5) configured to measure the temperature in the fuel cell unit (30). As a result, in the fuel cell activation device according to the eighth aspect, while activation of the fuel cell unit (30) is performed, it is possible to measure the temperature in the fuel cell unit (30) rising during power generation of the fuel cell unit (30) in a contactless manner at predetermined time intervals.

According to the fuel cell activation device of a ninth aspect of the present invention, in the foregoing first aspect, the cell temperature detection means (5) has a cell current detection means (174) configured to detect a value of a current flowing through the fuel cell unit (30). The control means (154) is configured to calculate the temperature in the fuel cell unit (30) on the basis of a change in the value of a current in the fuel cell unit (30) detected by the cell current detection means (174).

In the fuel cell activation device according to the ninth aspect, the control means (154) calculates the temperature in the fuel cell unit (30) on the basis of a change in the value of a current in the fuel cell unit (30) detected by the cell current detection means (174). For this reason, the cell current detection means (174) for detecting the value of a current flowing through the fuel cell unit (30) can function as the cell temperature detection means (5) configured to measure the temperature in the fuel cell unit (30). As a result, in the fuel cell activation device according to the ninth aspect, while activation of the fuel cell unit (30) is performed, it is possible to measure the temperature in the fuel cell unit (30) rising during power generation of the fuel cell unit (30) in a contactless manner at predetermined time intervals.

In the fuel cell activation device according to the present invention, the control means controls the temperature of anode gas and the temperature of the cathode gas supplied to the fuel cell unit, and executes heating of the anode gas and/or the cathode gas when the water vapor content in the fuel cell unit is equal to or larger than the saturation water vapor content.

For this reason, according to the fuel cell activation device of the present invention, when a fuel cell is activated using this, it is possible to prevent flooding from occurring in the fuel cell unit, and it is possible to sufficiently achieve the effect obtained by performing activation.

### BRIEF DESCRIPTION OF THE DRAWINGS

FIG. 1 is an explanatory schematic diagram of a fuel cell activation device according to the present embodiment.

FIG. 2 is an enlarged explanatory schematic diagram of fuel cell units activated by the fuel cell activation device shown in FIG. 1.

FIG. 3 is an explanatory flowchart of control processing executed by a control means in the fuel cell activation device shown in FIGS. 1 and 2.

### DETAILED DESCRIPTION OF THE INVENTION

In order to resolve the foregoing problems and prevent flooding from occurring during activation of fuel cell units of a fuel cell to achieve an excellent activation effect, the inventors have focused on the relationship between the water vapor content in the fuel cell units and the saturation water vapor content and have conducted extensive research as described below.

That is, flooding during activation of fuel cell units of a fuel cell occurs when the water vapor content in the fuel cell units exceeds the saturation water vapor content.

The saturation water vapor content varies depending on the temperature. The temperature in the fuel cell units during activation of the fuel cell units of the fuel cell rises in accordance with power generation of the fuel cell units. For this reason, the saturation water vapor content in the fuel cell units increases when the fuel cell units generate power. However, since water is produced by power generation for activation in the fuel cell units, the water vapor content in the fuel cell units also increases by power generation.

Therefore, in order to prevent flooding from occurring during activation of fuel cell units of a fuel cell, the insides of the fuel cell units need only be heated when the water vapor content in the fuel cell units becomes equal to or larger than the saturation water vapor content determined on the basis of the temperature in the fuel cell units.

Hence, the inventors have conducted extensive research into a means configured to judge whether or not the water vapor content in the fuel cell units is equal to or larger than the saturation water vapor content, and a means configured tor heat the insides of the fuel cell units when the water vapor content in the fuel cell units becomes equal to or larger than the saturation water vapor content.

As a result, the inventors have conceived the present invention upon finding that it is only necessary to heat anode gas supplied to an anode electrode and/or cathode gas supplied to a cathode electrode when the temperature in fuel cell units and the relative humidity in the fuel cell units are detected and the water vapor content in the fuel cell units is equal to or larger than the saturation water vapor content.

Hereinafter, a fuel cell activation device according to the present embodiment will be described in detail suitably with reference to the drawings. In the drawings used in the following description, in order to make characteristics of the present invention easy to understand, characteristic parts may be shown in an enlarged manner for the sake of convenience. Therefore, dimensional ratios or the like of each constituent element may differ from actual values thereof. Materials, dimensions, and the like shown in the following description are merely exemplary examples. The present invention is not limited thereto and can be suitably changed and performed within a range not changing the gist thereof.

### Fuel cell activation device

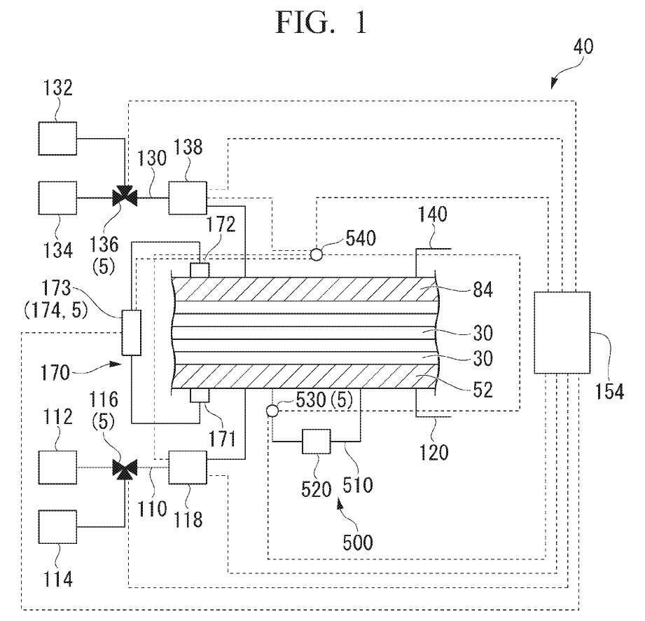

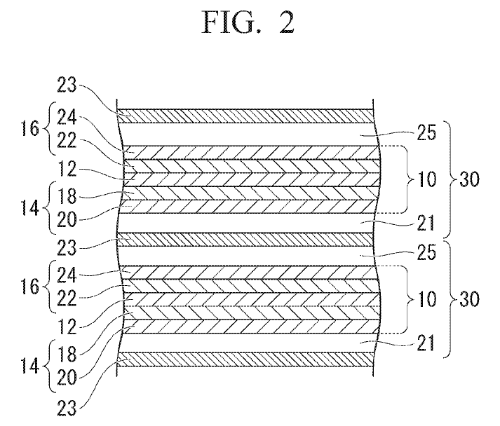

FIG. 1 is an explanatory schematic diagram of a fuel cell activation device according to the present embodiment. FIG. 2 is an enlarged explanatory schematic diagram of fuel cell units activated by the fuel cell activation device shown in FIG. 1.

As shown in FIG. 1, a fuel cell activation device 40 according to the present embodiment includes a first gas supply means 110, a second gas supply means 130, a cell potential measurement device 170, a cell cooling means 500, a relative humidity detection means 540, and a control means 154.

The fuel cell activation device 40 according to the present embodiment activates a plurality of stacked fuel cell units 30. For example, the plurality of fuel cell units 30 are connected in series.

In the present embodiment, a case where the plurality of fuel cell units 30 are stacked will be described as an example, but the fuel cell units 30 may be in only one layer. In addition, as shown in FIGS. 1 and 2, when the fuel cell units 30 are stacked, the number of stacked fuel cell units 30 is not particularly limited.

As shown in FIG. 1, the stacked fuel cell units 30 are disposed between a first end plate 52 and a second end plate 84 and are surrounded by a seal gasket (not shown), for example.

### Fuel cell unit 30

Each of the fuel cell units 30 shown in FIG. 1 has a first separator 21, a second separator 25, and a membrane electrode assembly (MEA) 10 disposed between the first separator 21 and the second separator 25, as shown in FIG. 2.

For example, each of the first separator 21 and the second separator 25 is constituted of a known fuel cell separator such as a metal separator made of stainless steel, aluminum, titanium, or the like, or a carbon separator.

As shown in FIG. 2, the membrane electrode assembly 10 has an anode electrode 14, a cathode electrode 16, and a solid polymer electrolyte membrane 12 sandwiched between the anode electrode 14 and the cathode electrode 16.

The solid polymer electrolyte membrane 12 is constituted of a proton-conducting ion exchange membrane. Specifically, regarding the solid polymer electrolyte membrane 12, for example, a membrane made of a fluorine-based resin such as perfluorosulfonic acid or a hydrocarbon-based resin can be used.

As shown in FIG. 2, the anode electrode 14 has a first electrode catalyst layer 18, and a first gas diffusion layer 20 for supplying gas to the first electrode catalyst layer 18.

The cathode electrode 16 has a second electrode catalyst layer 22, and a second gas diffusion layer 24 for supplying gas to the second electrode catalyst layer 22.

For each of the first electrode catalyst layer 18 and the second electrode catalyst layer 22, for example, a catalyst layer in which catalysts are supported by carriers such as carbon particles can be used. Examples of catalysts included in the first electrode catalyst layer 18 and the second electrode catalyst layer 22 include platinum catalysts and platinum alloy catalysts composed of platinum and other metals. In the present embodiment, it is preferable that one or both of the first electrode catalyst layer 18 and the second electrode catalyst layer 22 contain platinum catalysts. The reason is that a fuel cell having sufficient power generation performance can be obtained by activating the fuel cell units 30.

For each of the first gas diffusion layer 20 and the second gas diffusion layer 24, for example, a known fuel cell diffusion layer, such as a carbon cloth using carbon nonwoven fabric, or carbon paper, can be used.

### First gas supply means 110

The first gas supply means 110 supplies anode gas to the anode electrode 14 provided in the fuel cell unit 30. As shown in FIG. 1, the first gas supply means 110 has a hydrogen gas supply unit 112, a nitrogen gas supply unit 114, a first three-way valve 116 to which the hydrogen gas supply unit 112 and the nitrogen gas supply unit 114 are connected, and a first humidifier 118. An end portion of the first gas supply means 110 on the first humidifier 118 side penetrates the first end plate 52 and is joined to the anode electrode 14 provided in the fuel cell unit 30 by a known method.

The first humidifier 118 humidifies hydrogen-containing anode gas and also functions as a first heating means configured to heat anode gas. It is preferable that the first humidifier 118 be provided, but it may not be provided. That is, instead of the first humidifier 118, another heating means configured to only function as the first heating means may be provided.

Since the fuel cell activation device 40 according to the present embodiment has the first humidifier 118, when the fuel cell unit 30 is activated, the hydrogen-containing anode gas can be humidified so that the solid polymer electrolyte membrane 12 provided in the membrane electrode assembly (MEA) 10 of the fuel cell unit 30 (refer to FIG. 2) can be sufficiently hydrated. For this reason, the proton conductivity in the membrane electrode assembly 10 is improved, and a better activation effect can be achieved.

In addition, in the fuel cell activation device 40 according to the present embodiment, the first humidifier 118 also functions as the first heating means configured to heat anode gas. For this reason, the inside of the fuel cell unit 30 can be heated by supplying heated anode gas to the anode electrode 14. Therefore, when the water vapor content in the fuel cell units 30 is equal to or larger than a saturation water vapor content, the inside of the fuel cell unit 30 can be heated using the first humidifier 118.

For example, the hydrogen gas supply unit 112 is a hydrogen gas tank. For example, the nitrogen gas supply unit 114 is a nitrogen gas tank. The first three-way valve 116 adjusts the hydrogen concentration in anode gas and the flow rate of anode gas by adjusting the flow rate of hydrogen gas supplied from the hydrogen gas supply unit 112 and the flow rate of nitrogen gas supplied from the nitrogen gas supply unit 114.

In the present embodiment, the anode gas supplied to the anode electrode 14 need only be hydrogen-containing gas. It may be a mixed gas containing hydrogen and nitrogen in any ratio or may be hydrogen only. It is preferably a mixed gas of hydrogen and nitrogen.

The first gas supply means 110 has a first exhaust line 120 for emitting excess anode gas which has been distributed through the fuel cell unit 30. One end portion of the first exhaust line 120 penetrates the first end plate 52 and is joined to the anode electrode 14 provided in the fuel cell unit 30 by a known method.

As shown in FIG. 1, the first humidifier 118 and the first three-way valve 116 of the first gas supply means 110 are electrically connected to the control means 154.

The temperature and the relative humidity of anode gas humidified by the first humidifier 118 are controlled by control signals from the control means 154. The first humidifier 118 outputs signals of the temperature and the relative humidity of anode gas. The output signals output from the first humidifier 118 are input to the control means 154.

In addition, the hydrogen concentration in anode gas and the flow rate of anode gas supplied through the first three-way valve 116 are controlled by control signals from the control means 154. The first three-way valve 116 can also function as a part of a cell temperature detection means 5 for measuring the temperature in the fuel cell unit 30 and outputs signals of the hydrogen concentration in anode gas and the flow rate of anode gas to be supplied. The output signals output from the first three-way valve 116 are input to the control means 154.

### Second gas supply means 130

The second gas supply means 130 supplies cathode gas to the cathode electrode 16 of the fuel cell unit 30. The second gas supply means 130 has a nitrogen gas supply unit 132, an oxygen-containing gas supply unit 134, a second three-way valve 136 to which the nitrogen gas supply unit 132 and the oxygen-containing gas supply unit 134 are connected, and a second humidifier 138. An end portion of the second gas supply means 130 on the second humidifier 138 side penetrates the second end plate 84 and is joined to the cathode electrode 16 provided in the fuel cell unit 30 by a known method.

The second humidifier 138 humidifies oxygen-containing cathode gas and also functions as a second heating means configured to heat cathode gas. It is preferable that the second humidifier 138 be provided, but it may not be provided. That is, instead of the second humidifier 138, another heating means configured only to function as the second heating means may be provided.

Since the fuel cell activation device 40 according to the present embodiment has the second humidifier 138, when the fuel cell unit 30 is activated, the oxygen-containing cathode gas can be humidified so that the solid polymer electrolyte membrane 12 provided in the membrane electrode assembly (MEA) 10 of the fuel cell unit 30 (refer to FIG. 2) can be sufficiently hydrated. For this reason, the proton conductivity in the membrane electrode assembly 10 is improved, and a better activation effect can be achieved.

In addition, in the fuel cell activation device 40 according to the present embodiment, the second humidifier 138 also functions as the second heating means configured to heat cathode gas. For this reason, the inside of the fuel cell unit 30 can be heated by supplying heated cathode gas to the cathode electrode 16. Therefore, when the water vapor content in the fuel cell units 30 is equal to or larger than the saturation water vapor content, the inside of the fuel cell unit 30 can be heated using the second humidifier 138.

For example, the oxygen-containing gas supply unit 134 is a compressor compressing atmospheric air. The oxygen-containing gas supply unit 134 may be an oxygen gas cylinder. For example, the nitrogen gas supply unit 132 is a nitrogen gas tank. The second three-way valve 136 adjusts the oxygen concentration in cathode gas and the flow rate of cathode gas by adjusting the flow rate of oxygen-containing gas supplied from the oxygen-containing gas supply unit 134 and the flow rate of nitrogen gas supplied from the nitrogen gas supply unit 132.

In the present embodiment, the cathode gas supplied to the cathode electrode 16 need only be oxygen-containing gas. It may be a mixed gas containing oxygen and nitrogen in any ratio or may be air. It can be suitably determined in accordance with the hydrogen concentration in anode gas, the flow rate of anode gas, and the like supplied to the anode electrode 14.

In the present embodiment, it is preferable to use low-oxygen gas having a lower oxygen concentration than air as cathode gas. For example, the reason is that the amount of water produced by activating the fuel cell unit 30 can be suppressed compared to when the cathode gas is air or high-oxygen gas having an oxygen concentration equal to or higher than that of air. Accordingly, it is possible to prevent an excessive amount of water produced during activation of the fuel cell unit 30 of the fuel cell, and it is possible to more effectively prevent flooding from occurring in the fuel cell unit 30.

The second gas supply means 130 has a second exhaust line 140 for emitting excess cathode gas which has been distributed through the fuel cell unit 30. One end portion of the second exhaust line 140 penetrates the second end plate 84 and is joined to the cathode electrode 16 provided in the fuel cell unit 30 by a known method.

As shown in FIG. 1, the nitrogen gas supply unit 132 provided in the second gas supply means 130 may be provided separately from the nitrogen gas supply unit 114 provided in the first gas supply means 110. In addition, the nitrogen gas supply unit 114 provided in the first gas supply means 110 may be integrated with the nitrogen gas supply unit 132 provided in the second gas supply means 130. That is, the nitrogen gas supply unit 114 provided in the first gas supply means 110 may also serve as the nitrogen gas supply unit 132 provided in the second gas supply means 130.

As shown in FIG. 1, the second humidifier 138 and the second three-way valve 136 of the second gas supply means 130 are electrically connected to the control means 154.

The temperature and the relative humidity of cathode gas humidified by the second humidifier 138 are controlled by control signals from the control means 154. The second humidifier 138 outputs signals of the temperature and the relative humidity of cathode gas. The output signals output from the second humidifier 138 are input to the control means 154.

In addition, the oxygen concentration in cathode gas and the flow rate of cathode gas supplied through the second three-way valve 136 are controlled by control signals from the control means 154. The second three-way valve 136 can also function as a part of the cell temperature detection means 5 configured to measure the temperature in the fuel cell unit 30 and outputs signals of the oxygen concentration in cathode gas and the flow rate of cathode gas to be supplied. The output signals output from the second three-way valve 136 are input to the control means 154.

### Cell potential measurement device 170

The cell potential measurement device 170 measures the potential of the fuel cell units 30.

In the present embodiment, regarding the cell potential measurement device 170, a device measuring the potential of the plurality of stacked fuel cell units 30 will be described as an example, but a device measuring the potential of one fuel cell unit 30 may be used as the cell potential measurement device 170.

As shown in FIG. 1, the cell potential measurement device 170 has a first connection terminal 171, a second connection terminal 172, and a cell potential detection means 173.

The first connection terminal 171 is electrically connected to the anode electrode 14 of each fuel cell unit 30 (refer to FIG. 2) by a known method. The second connection terminal 172 is electrically connected to the cathode electrode 16 of each fuel cell unit 30 (refer to FIG. 2) by a known method. Accordingly, the cell potential detection means 173 can detect a change in the potential corresponding to the amount of power generation during activation of the plurality of stacked fuel cell units 30.

The cell potential detection means 173 detects the potential of the fuel cell units 30. The cell potential detection means 173 can also function as the cell temperature detection means 5 for measuring the temperature in the fuel cell unit 30 and is electrically connected to the control means 154, as shown in FIG. 1. The cell potential detection means 173 outputs signals of the potential of the plurality of stacked fuel cell units 30. The output signals output from the cell potential detection means 173 are input to the control means 154. A known potential measurement device or the like used in a fuel cell or the like can be used as the cell potential detection means 173.

In the present embodiment, a means functioning as a cell current detection means 174 is used as the cell potential detection means 173. The cell current detection means 174 detects the value of a current flowing through the fuel cell units 30. In the present embodiment, regarding the cell current detection means 174, a detection means configured to measure the value of a current flowing through the plurality of stacked fuel cell units 30 will be described as an example, but a detection means configured to measure the value of a current flowing through one fuel cell unit 30 may be used as the cell current detection means 174.

The cell current detection means 174 can also function as the cell temperature detection means 5 configured to measure the temperature in the fuel cell unit 30. The cell current detection means 174 outputs signals of the value of a current flowing through the plurality of stacked fuel cell units 30. The output signals output from the cell current detection means 174 are input to the control means 154. A known current measurement device or the like used in a fuel cell or the like can be used as the cell current detection means 174.

### Cell cooling means 500

A cell cooling means 500 cools the stacked fuel cell units 30. As shown in FIG. 1, the cell cooling means 500 has a coolant piping 510, a radiator 520, a coolant temperature detection means 530, and a coolant flow channel 23 (refer to FIG. 2).

Both end portions of the coolant piping 510 penetrate the first end plate 52 and are coupled to the coolant flow channel 23 by a known method. As shown in FIG. 2, each coolant flow channel 23 is disposed between adjacent ones of stacked fuel cell units 30. When each coolant flow channel 23 is disposed between adjacent ones of stacked fuel cell units 30, each of the stacked fuel cell units 30 can be efficiently cooled, which is preferable. In addition, when each coolant flow channel 23 is disposed between adjacent ones of stacked fuel cell units 30, the correlation between the temperature of a coolant and the temperature in the fuel cell units 30 becomes stronger. For this reason, when the coolant temperature detection means 530 is used as the cell temperature detection means 5 configured to measure the temperature in the fuel cell units 30, the saturation water vapor content in the fuel cell unit 30 can be calculated with high accuracy.

In the present embodiment, a case where each coolant flow channel 23 is disposed between adjacent ones of stacked fuel cell units 30 will be described as an example, but the disposition and the shape of the coolant flow channel 23 are not particularly limited.

The coolant flowing through the coolant piping 510 and the coolant flow channel 23 cools the fuel cell units 30 and circulates at a predetermined flow velocity by a cooling pump (not shown).

The radiator 520 cools the coolant circulating through the coolant piping 510 and the coolant flow channel 23.

The coolant temperature detection means 530 detects the temperature of the coolant circulating through the coolant piping 510 and the coolant flow channel 23. The coolant temperature detection means 530 can also function as the cell temperature detection means 5 configured to measure the temperature in the fuel cell units 30 and is electrically connected to the control means 154, as shown in FIG. 1. The coolant temperature detection means 530 outputs signals of the temperature of the coolant for cooling the fuel cell units 30. The output signals output from the coolant temperature detection means 530 are input to the control means 154.

### Cell temperature detection means 5

The cell temperature detection means 5 is configured to measure the temperature in the fuel cell units 30. As shown in FIG. 1, the fuel cell activation device 40 according to the present embodiment has, as the cell temperature detection means 5, the cell potential detection means 173 of the cell potential measurement device 170, the cell current detection means 174, the first three-way valve 116 of the first gas supply means 110 and the second three-way valve 136 of the second gas supply means 130 (gas supply amount detection means), and the coolant temperature detection means 530. As shown in FIG. 1, each cell temperature detection means 5 is electrically connected to the control means 154.

A case where the fuel cell activation device 40 has, as the cell temperature detection means 5, four detection means such as the cell potential detection means 173, the cell current detection means 174, the first three-way valve 116 of the first gas supply means 110 and the second three-way valve 136 of the second gas supply means 130, and the coolant temperature detection means 530 will be described as an example, but it may have only one selected from the foregoing four detection means or may have only two or three of them.

In addition, the fuel cell activation device 40 according to the present embodiment includes the first three-way valve 116 and the second three-way valve 136 as the gas supply amount detection means. The first three-way valve 116 detects the flow rate of hydrogen supplied by the first gas supply means 110. The second three-way valve 136 detects the flow rate of oxygen supplied by the second gas supply means 130. As shown in FIG. 1, the first three-way valve 116 and the second three-way valve 136 are electrically connected to the control means 154.

### Relative humidity detection means 540

The relative humidity detection means 540 executes measurement of the relative humidity in the fuel cell units 30 using the control means 154. The relative humidity detection means 540 need only be able to measure the relative humidity in the fuel cell units 30, and a known detection means can be used.

In the present embodiment, regarding the relative humidity detection means 540, a detection means configured to calculate the relative humidity in the fuel cell units 30 on the basis of the temperature of the coolant sent from the coolant temperature detection means 530 of the cell cooling means 500, the value of a current sent from the cell current detection means 174 and flowing through the fuel cell units 30, the water vapor content supplied to the anode gas sent from the first heating means 118, the water vapor content supplied to the cathode gas sent from the second heating means 138 (second humidifier) is installed.

More specifically, the relative humidity detection means 540 is configured to calculate the temperature in the fuel cell units 30 and calculates the saturation water vapor content corresponding to the temperature in the fuel cell units 30 on the basis of the temperature of the coolant detected by the coolant temperature detection means 530, and on the basis of the standard curve indicating the relationship between the temperature of the coolant measured in advance and the temperature in the fuel cell units 30.

In addition, the relative humidity detection means 540 calculates the amount of water produced in the fuel cell units 30 on the basis of the value of a current sent from the cell current detection means 174 and flowing through the fuel cell units 30, and on the basis of the standard curve indicating the relationship between the value of a current flowing through the fuel cell units 30 measured in advance and the amount of water produced by power generation in the fuel cell units 30.

Further, the relative humidity detection means 540 calculates the relative humidity in the fuel cell units 30 using the saturation water vapor content corresponding to the temperature in the fuel cell units 30 acquired as described above, the amount of water produced in the fuel cell units 30, and the water vapor content supplied by the first heating means 118 (first humidifier) and the second heating means 138 (second humidifier). Accordingly, the relative humidity detection means 540 can measure, in a contactless manner, the relative humidity in the fuel cell units 30 which varies during power generation of the fuel cell units (30).

As shown in FIG. 1, the relative humidity detection means 540 is electrically connected to the coolant temperature detection means 530 of the cell cooling means 500, the first heating means 118 (first humidifier), the second heating means 138 (second humidifier), the cell current detection means 174, and the control means 154. The relative humidity detection means 540 outputs signals of the relative humidity in the fuel cell units 30 calculated on the basis of the coolant temperature input from the coolant temperature detection means 530, the value of a current of the fuel cell unit 30 input from the cell current detection means 174, the water vapor content supplied to the anode gas input from the first heating means 118 (first humidifier), and the supply amount of water vapor supplied to the cathode gas input from the second heating means 138 (second humidifier). The output signals output from the relative humidity detection means 540 are input to the control means 154.

### Control means 154

The control means 154 is configured to control the temperature of anode gas supplied by the first gas supply means 110 and the temperature of cathode gas supplied by the second gas supply means 130.

The control means 154 is configured to execute heating of the anode gas and/or the cathode gas when the water vapor content in the fuel cell units 30 is equal to or larger than the saturation water vapor content.

Specifically, the control means 154 calculates the saturation water vapor content in the fuel cell unit 30 on the basis of the temperature in the fuel cell units 30 sent from the cell temperature detection means 5. In addition, the control means 154 calculates the water vapor content in the fuel cell units 30 on the basis of the relative humidity in the fuel cell units 30 sent from the relative humidity detection means 540.

Further, the control means 154 executes heating of the anode gas supplied to the anode electrode 14 by the first humidifier 118 of the first gas supply means 110 and/or heating of the cathode gas supplied to the cathode electrode 16 by the second humidifier 138 of the second gas supply means 130 when the water vapor content in the fuel cell units 30 is equal to or larger than the saturation water vapor content.

The control means 154 can use the cell potential detection means 173 as the cell temperature detection means 5. In this case, the control means 154 calculates the current flowing through the stacked fuel cell units 30 on the basis of a change in the potential of the fuel cell units 30 detected by the cell potential detection means 173 and sent from the cell potential detection means 173. When the current flowing through the stacked fuel cell units 30 increases, the temperature in the fuel cell units 30 rises.

The control means 154 can use the cell current detection means 174 as the cell temperature detection means 5. In this case, the control means 154 calculates the temperature in the fuel cell units 30 on the basis of a change in the value of a current of the fuel cell unit 30 detected by the cell current detection means 174 and sent from the cell current detection means 174. When the current flowing through the stacked fuel cell units 30 increases, the temperature in the fuel cell units 30 rises.

In the present embodiment, the control means 154 calculates the temperature in the fuel cell units 30 on the basis of the standard curve indicating the relationship between the value of a current flowing through the stacked fuel cell units 30 measured in advance and the temperature in the fuel cell units 30. Therefore, using the cell potential detection means 173 and/or the cell current detection means 174 as the cell temperature detection means 5, while activation of the fuel cell units 30 is performed, the temperature in the fuel cell units 30 rising during power generation of the fuel cell units 30 can be measured in a contactless manner at predetermined time intervals.

In addition, the control means 154 can use the first three-way valve 116 and the second three-way valve 136 as the cell temperature detection means 5. In this case, the control means 154 is configured to calculate the oxygen supply ratio that is a ratio of the flow rate of oxygen to the flow rate of hydrogen on the basis of the flow rate of hydrogen sent from the first three-way valve 116, determined by the opening degree of the first three-way valve 116, and supplied by the first gas supply means 110; and the flow rate of oxygen sent from the second three-way valve 136, determined by the opening degree of the second three-way valve 136, and supplied by the second gas supply means 130.

If the supply ratio of oxygen supplied to the stacked fuel cell units 30 increases, the amount of power generation during activation of the fuel cell units 30 increases, and the temperature in the fuel cell units 30 rises. In addition, when the oxygen supply ratio is the same, as the flow rates of oxygen and hydrogen increase, the amount of power generation during activation of the fuel cell units 30 increases and the temperature in the fuel cell units 30 rises.

In the present embodiment, the control means 154 calculates the temperature in the fuel cell units 30 on the basis of the standard curve indicating the relationship between the supply ratio of oxygen supplied to the stacked fuel cell units 30 measured in advance and the temperature in the fuel cell units 30, and the standard curve indicating the relationship between the total amount of the flow rate of oxygen and the flow rate of hydrogen and the temperature in the fuel cell units 30. Therefore, while activation of the fuel cell units 30 is performed, the temperature in the fuel cell units 30 rising during power generation of the fuel cell units 30 can be measured in a contactless manner at predetermined time intervals.

In addition, when the control means 154 uses the first three-way valve 116 and the second three-way valve 136 as the cell temperature detection means 5, the control means 154 controls the flow rate of hydrogen supplied by the first gas supply means 110 and the flow rate of oxygen supplied by the second gas supply means 130, and when the water vapor content in the fuel cell units 30 is equal to or larger than the saturation water vapor content, it is preferable to execute reduction of the oxygen supply ratio. In this case, when the water vapor content in the fuel cell units 30 becomes equal to or larger than the saturation water vapor content, the electrochemical reaction is suppressed as a result of insufficient oxygen, and the amount of power generation during activation of the fuel cell units 30 is reduced. For this reason, the amount of water produced by power generation for activation decreases, and it is possible to more effectively prevent flooding from occurring during activation of the fuel cell units 30.

In addition, the control means 154 can use the coolant temperature detection means 530 as the cell temperature detection means 5. In this case, the temperature in the fuel cell units 30 is calculated on the basis of a change in the temperature of the coolant for cooling the fuel cell units 30 sent from the coolant temperature detection means 530 and detected by the coolant temperature detection means 530. Specifically, when the amount of power generation during activation of the fuel cell units 30 increases, the temperature of the coolant for cooling the fuel cell units 30 rises and the temperature in the fuel cell units 30 rises. In the present embodiment, the control means 154 calculates the temperature in the fuel cell units 30 on the basis of the standard curve indicating the relationship between the temperature of the coolant measured in advance and the temperature in the fuel cell units 30. Therefore, while activation of the fuel cell units 30 is performed, the temperature in the fuel cell units 30 rising during power generation of the fuel cell units 30 can be measured in a contactless manner at predetermined time intervals.

In addition, when the fuel cell activation device 40 has the first humidifier 118, it is preferable that the control means 154 reduce the humidification amount by the first humidifier 118 when the water vapor content in the fuel cell units 30 is equal to or larger than the saturation water vapor content. In this case, the water vapor content in the fuel cell units 30 is suppressed. For this reason, it is possible to more effectively prevent flooding from occurring during activation of the fuel cell units 30.

In addition, when the fuel cell activation device 40 has the second humidifier 138, it is preferable that the control means 154 reduce the humidification amount by the second humidifier 138 when the water vapor content in the fuel cell units 30 is equal to or larger than the saturation water vapor content. In this case, the water vapor content in the fuel cell units 30 is suppressed. For this reason, it is possible to more effectively prevent flooding from occurring during activation of the fuel cell units 30.

For example, an electronic control unit (ECU) can be used as the control means 154. The control means 154 is constituted of a microcomputer including a CPU, a RAM, a ROM, an E2PROM, an I/O interface, and the like. The control means 154 executes control processing in accordance with a control program stored in the ROM on the basis of one or more signals input from the first humidifier 118, the second humidifier 138, the first three-way valve 116, the second three-way valve 136, the cell potential detection means 173, the coolant temperature detection means 530, and the relative humidity detection means 540.

Next, control processing executed by the control means 154 in the fuel cell activation device 40 according to the present embodiment will be described.

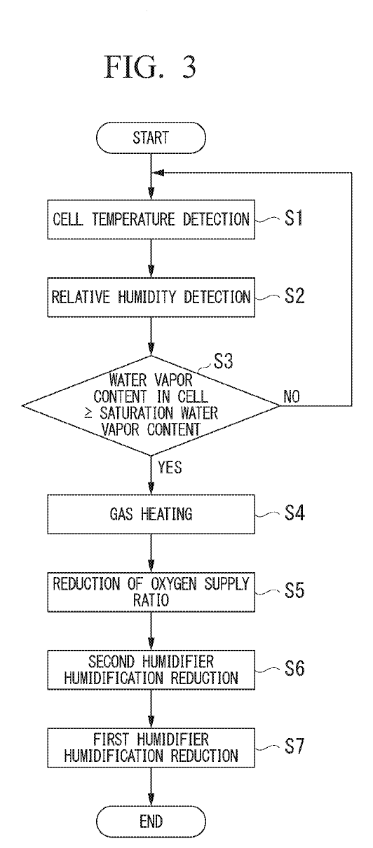

FIG. 3 is an explanatory flowchart of control processing executed by the control means 154 in the fuel cell activation device 40 shown in FIGS. 1 and 2.

In the present embodiment, first, the control means 154 causes the cell temperature detection means 5 to detect the temperature in the fuel cell units 30 (Step S1). Further, the control means 154 calculates the saturation water vapor content in the fuel cell unit 30 on the basis of the temperature in the fuel cell units 30 sent from the cell temperature detection means 5.

In the present embodiment, the control means 154 can use output signals from any one detection means selected from the cell potential detection means 173, the cell current detection means 174, the first three-way valve 116 and the second three-way valve 136 (gas supply amount detection means), and the coolant temperature detection means 530 shown in FIG. 1. It is preferable that the one detection means selected from the four detection means be the coolant temperature detection means 530. The reason is that the coolant temperature detection means 530 can measure the temperature in the fuel cell units 30 with high accuracy.

Next, the control means 154 causes the relative humidity detection means 540 to detect the relative humidity in the fuel cell units 30 (Step S2). Further, the control means 154 calculates the water vapor content in the fuel cell units 30 on the basis of the relative humidity in the fuel cell units 30 sent from the relative humidity detection means 540.

Next, the control means 154 decides whether or not the water vapor content in the fuel cell units 30 calculated in Step S2 is equal to or larger than the saturation water vapor content calculated in Step S1 (Step S3).

Further, when the water vapor content in the fuel cell units 30 is smaller than the saturation water vapor content, the control means 154 returns to Step S1, and causes the cell temperature detection means 5 to detect the temperature in the fuel cell units 30 again.

Meanwhile, when the water vapor content in the fuel cell units 30 is equal to or larger than the saturation water vapor content, the control means 154 executes heating of the anode gas using the first humidifier 118 that is the first heating means of the first gas supply means 110 and/or heating of the cathode gas using the second humidifier 138 that is the second heating means of the second gas supply means 130 (Step S4).

In the present embodiment, when Step S4 is performed, the temperature in the fuel cell units 30 rises. As a result, the saturation water vapor content in the fuel cell unit 30 increases, and the water vapor content in the fuel cell units 30 becomes smaller than the saturation water vapor content. Accordingly, flooding is prevented from occurring during activation of the fuel cell units 30.

When the first three-way valve 116 and the second three-way valve 136 are used as the cell temperature detection means 5 in Step S1, it is preferable that the control means 154 execute reduction of the oxygen supply ratio as necessary after Step S4 (Step S5). Accordingly, the amount of water produced by power generation for activation decreases, and it is possible to more effectively prevent flooding from occurring during activation of the fuel cell units 30.

In Step S5, specifically, the control means 154 executes one kind or more kinds of processing selected from reducing the flow rate of oxygen-containing gas supplied from the oxygen-containing gas supply unit 134 using the second three-way valve 136, increasing the flow rate of nitrogen gas supplied from the nitrogen gas supply unit 132 using the second three-way valve 136, increasing the flow rate of hydrogen gas supplied from the hydrogen gas supply unit 112 using the first three-way valve 116, and increasing the flow rate of nitrogen gas supplied from the nitrogen gas supply unit 114 using the first three-way valve 116.

When the fuel cell activation device 40 has the second humidifier 138, the control means 154 executes reduction of the humidification amount by the second humidifier 138 as necessary after Step S5 (Step S6). Accordingly, the relative humidity of the cathode gas is reduced, and the saturation water vapor content in the fuel cell unit 30 decreases so that it is possible to more effectively prevent flooding from occurring during activation of the fuel cell units 30.

When the fuel cell activation device 40 has the first humidifier 118, the control means 154 executes reduction of the humidification amount by the first humidifier 118 as necessary after Step S6 (Step S7). Accordingly, the relative humidity of the anode gas is reduced, and the saturation water vapor content in the fuel cell unit 30 decreases so that it is possible to more effectively prevent flooding from occurring during activation of the fuel cell units 30.

In the present embodiment, as shown in FIG. 3, a case where Step S2 is performed after Step S1 is performed has been described as an example. However, Step S1 may be performed after Step S2 is performed. In addition, Steps S1 and S2 may be performed consecutively at the same time, or Steps S1 and S2 may be performed repeatedly a plurality of times.

In the present embodiment, a case where Step S6 is performed after Step S5 is performed has been described as an example. However, Step S6 may be performed before Step S5, or Step S6 may be performed without performing Step 5.

In the present embodiment, a case where Step S7 is performed after Step S6 is performed has been described as an example. However, Step S7 may be performed after Step S4 without performing Step 5 and/or Step S6, and the order Steps S5 to S7 is not particularly limited.

In addition, as shown in FIG. 3, all of Steps S5 to S7 may be executed, but a part or all of Steps S5 to S7 may not be executed. That is, the control processing by the control means 154 according to the present embodiment may end after Step S4 ends or may end without executing Steps S5 to S7. In addition, a part or all of Steps S5 to S7 may be performed repeatedly a plurality of times.

Hereinabove, an embodiment of the present invention has been described. However, the foregoing embodiment of the present invention is intended to facilitate understanding of the present invention and is not intended to limit the present invention. The present invention can be changed and improved without departing from the gist thereof and the claims, and it is natural that the present invention includes equivalents thereof.

### EXPLANATION OF REFERENCES

5 Cell temperature detection means

10 Membrane electrode assembly (MEA)

12 Solid polymer electrolyte membrane

14 Anode electrode

16 Cathode electrode

18 First electrode catalyst layer

22 Second electrode catalyst layer

30 Fuel cell unit

40 Fuel cell activation device

110 First gas supply means

112 Hydrogen gas supply unit

114 Nitrogen gas supply unit

116 First three-way valve (gas supply amount detection means)

118 First heating means (first humidifier)

130 Second gas supply means

132 Nitrogen gas supply unit

134 Oxygen-containing gas supply unit

136 Second three-way valve (gas supply amount detection means)

138 Second heating means (second humidifier)

154 Control means

170 Cell potential measurement device

173 Cell potential detection means

174 Cell current detection means

500 Cell cooling means

530 Coolant temperature detection means

540 Relative humidity detection means

What is claimed is:

1. A fuel cell activation device activating a fuel cell unit having an anode electrode, a cathode electrode, and a solid polymer electrolyte membrane sandwiched between the anode electrode and the cathode electrode, the device comprising:
a first gas supply means having a first heating means configured to heat hydrogen-containing anode gas, the first gas supply means being configured to supply the anode gas to the anode electrode;
a second gas supply means having a second heating means configured to heat oxygen-containing cathode gas, the second gas supply means being configured to supply the cathode gas to the cathode electrode;
a control means configured to control a temperature of anode gas supplied by the first gas supply means and a temperature of the cathode gas supplied by the second gas supply means;
a cell temperature detection means configured to measure a temperature in the fuel cell unit; and
a relative humidity detection means configured to measure a relative humidity in the fuel cell unit,
wherein the control means is configured to execute heating of the anode gas and/or the cathode gas when a water vapor content in the fuel cell unit is equal to or larger than a saturation water vapor content.

2. The fuel cell activation device according to claim 1,
wherein the cathode gas is low-oxygen gas having a lower oxygen concentration than air.

3. The fuel cell activation device according to claim 1,
wherein one or both of the anode electrode and the cathode electrode have a catalyst layer containing platinum catalysts.

4. The fuel cell activation device according to claim 1,
wherein the first gas supply means has a first humidifier humidifying hydrogen-containing anode gas, and
the second gas supply means has a second humidifier humidifying oxygen-containing cathode gas.

5. The fuel cell activation device according to claim 1,
wherein the cell temperature detection means has a cell potential detection means configured to detect a potential of the fuel cell unit, and
the control means is configured to calculate the temperature in the fuel cell unit on the basis of a change in the potential of the fuel cell unit detected by the cell potential detection means.

6. The fuel cell activation device according to claim 1,
wherein the cell temperature detection means has a gas supply amount detection means configured to detect a flow rate of hydrogen supplied by the first gas supply means and a flow rate of oxygen supplied by the second gas supply means, and
the control means is configured to calculate an oxygen supply ratio that is a ratio of the flow rate of the oxygen to the flow rate of the hydrogen on the basis of the flow rate of the hydrogen and the flow rate of the oxygen detected by the gas supply amount detection means and calculates the temperature in the fuel cell unit using the result thereof.

7. The fuel cell activation device according to claim 6,
wherein the control means is configured to control the flow rate of hydrogen supplied by the first gas supply means and the flow rate of oxygen supplied by the second gas supply means, and
reduction of the oxygen supply ratio is executed when the water vapor content in the fuel cell unit is equal to or larger than the saturation water vapor content.

8. The fuel cell activation device according to claim 1,
wherein the cell temperature detection means has a coolant temperature detection means configured to detect a temperature of a coolant for cooling the fuel cell unit, and
the control means is configured to calculate the temperature in the fuel cell unit on the basis of a change in the temperature of the coolant detected by the coolant temperature detection means.

9. The fuel cell activation device according to claim 1,
wherein the cell temperature detection means has a cell current detection means configured to detect a value of a current flowing through the fuel cell unit, and
the control means is configured to calculate the temperature in the fuel cell unit on the basis of a change in the value of a current in the fuel cell unit detected by the cell current detection means.
